(19) United States
(12) Patent Application Publication
(10) Pub. No.: US 2007/0158997 A1
(43) Pub. Date: Jul. 12, 2007

(54) Multi-Piece Wheel Having An Independently Rotating Lip And Integrated Fiber Optics

(76) Inventor: George Raymond, Miami, FL (US)

Correspondence Address: CAHN & SAMUELS LLP, 2000 P STREET NW, SUITE 200, WASHINGTON, DC, 20036, US

(21) Appl. No.: 11/560,712

(22) Filed: Nov. 16, 2006

Related U.S. Application Data
(60) Provisional application No. 60/736,856, filed on Nov. 16, 2005.

(51) Int. Cl. B60B 7/16

(52) U.S. Cl. 301/37.21

(57) ABSTRACT

A multi-piece automobile wheel having an independently rotating lip and integrated fiber optic system. The wheel is enhanced by the luminescence and visual effect created by the rotating lip. The lip rotates on an internal bearing system attached to the hub of the wheel. Fiber optics can also be integrated into the wheel to further enhance the luminescence and visual effect of the wheel. The fiber optics may also be integrated within the bolts and rivets on the face of the wheel. The wheel may include various designs and materials to further enhance the appearance.

### I. CROSS-REFERENCE TO RELATED APPLICATIONS

This application claims the benefit of U.S. Provisional Patent Application Ser. No. 60/736,856 filed Nov. 16, 2005, incorporated herein by reference.

### II. FIELD OF THE INVENTION

This invention relates to a multi-piece wheel assembly. Specifically, a multi-piece automotive wheel having an independently rotating lip and integrated fiber optics wherein the visual effect of the wheel is enhanced by the rotating lip and light emitted onto the wheel by the fiber optics.

### III. BACKGROUND OF THE INVENTION

The specialty automotive equipment industry is defined by products and services that modify the performance, appearance, and/or handling of vehicles, including passenger cars and trucks, motorcycles, ATVs, boats, etc. Over the last several years, the specialty automotive equipment industry has grown at a phenomenal pace. This growth is expected to continue for at least the next several years.

Much of the growth in the specialty automotive equipment industry has been attributed to an emerging shift of many automobile consumers into automobile enthusiasts. Today, these enthusiasts and consumers have a strong desire for custom and personalized automotive products. Enthusiasts, in particular, are often essentially using automobile manufacturers to provide a template that allows them to create a completely unique automobile.

Most frequently, the initial and most noticeable step enthusiasts undertake when customizing or personalizing their automobile is to replace their stock wheels with custom wheels. With over 130 manufacturers of OEM and custom wheels, consumers have a wide variety of styles to choose from. The custom wheel segment, within the specialty automotive equipment industry, is generally further divided into two manufacturing segments, one-piece wheel manufacturers and multi-piece wheel manufacturers. One-piece wheels tend to be directed towards consumers that have a high sensitivity to price and a lower sensitivity to the complexity, performance and appearance of the wheel. Multi-piece wheels, often constructed of forged alloy, tend to be directed towards customers that have a low sensitivity to price and require the highest quality materials, craftsmanship and designs.

The multi-piece wheel segment includes many manufacturers, such as Lexani Corporation (Corona, Calif.), HRE Performance Wheels (Vista, Calif.), KMC Products, Inc. (Riverside, Calif.), and others. This segment has recently experienced creativity like no other automotive equipment industry segment. For example, consumers have the option of purchasing extravagant accents for their wheels, such as jewelry-like embellishments. In fact, Lexani Corporation manufactures a line of wheels embellished with cubic zirconium jewels in order to enhance the luminescence and appearance of the wheel. Wheels in this line retail for between $250,000 and $1,000,000 per set.

Enthusiasts are increasingly seeking custom wheels that have a very unique design. While the overall design of the wheel including the faceplate remains important, enthusiasts place a high importance on particular elements of the design. Today, one of the most important features of a custom wheel is the width or depth of the lip of the wheel. The lip of the wheel is the radial portion of the wheel where the wheel meets the tire. The demand for a wider or more detailed lip has not been widely significant until very recently.

One of the increasingly popular style of wheels is known as the spinning wheel or “spinner”. These wheels include a spinning faceplate that rotates or spins independently over an attached wheel. U.S. Pat. No. 6,554,370 to Fowlkes discloses an example of a spinning wheel. While these designs are very popular, their focus has been on rotating or spinning the faceplate of the wheel. No attention has been given to rotating the lip of the wheel independent of the faceplate or hub.

Fiber optics can be defined as a single strand or a plurality of strands of optically pure glass or plastic as thin as a human hair that carry digital information over long distances with no or little signal loss. Fiber optics has been primarily used for communication, but is now finding applications in aesthetic products. Fiber optics has been used on automotive wheels to enhance the luminescence of the face of the wheel. U.S. Pat. No. 4,430,692 to Papadakis shows a wheel system for illuminating an automobile wheel having a light bulb disposed on the automobile and a series of several fiber optic light guides mechanically coupled together to transmit light from the light bulb to the central cap of the wheel.

Notwithstanding the usefulness of the above-described apparatuses and methods, a need still exists for a system and method for enhancing and accentuating the luminescence and appearance of an automotive wheel, specifically the lip on the wheel, including providing a rotating lip on the wheel and illuminating the wheel and lip with an integrated, on-board fiber optic lighting system.

### IV. SUMMARY OF THE INVENTION

This invention in at least one embodiment provides a multi-piece automotive wheel assembly comprising a hub, a faceplate coupled to said hub, and a rotating lip coupled to said hub or faceplate, wherein said rotating lip rotates with respect to said hub or faceplate.

This invention in at least one embodiment provides a multi-piece automotive wheel assembly comprising a hub, a faceplate coupled to said hub, a lip engaged with one of said hub and faceplate, and means for facilitating rotation of said lip with respect to said hub or faceplate.

This invention in at least one embodiment provides a wheel lip assembly for attaching a rotating lip to a hub or faceplate of an automotive wheel, said lip assembly comprising a rotating lip mounting flange capable of being coupled to said hub or faceplate, wherein said rotating lip mounting flange includes a bearing system coupled to and spaced along said rotating lip mounting flange, and a rotating lip coupled to said rotating lip mounting flange, wherein said rotating lip rotates with respect to said hub or faceplate.

This invention in at least one embodiment provides a lighted wheel assembly, comprising a hub, including a lip; a faceplate coupled to said hub; a light source that generates light coupled to said hub or faceplate; and, at least one optical fiber coupled to said light source, wherein said optical fiber transmits light generated by said light source to said hub or faceplate.

These preceding embodiments are mentioned for the purpose of merely describing the basic embodiments of the claimed invention. Other embodiments will be described in the detailed description of the claimed invention. However, those with ordinary skill in the art will appreciate that other embodiments not described would be achievable through these teachings.

Given the following enabling description of the drawings, the apparatus should become evident to a person of ordinary skill in the art.

### V. BRIEF DESCRIPTION OF THE DRAWINGS

The present invention is described with reference to the accompanying drawings, wherein:

FIG. 1 illustrates a multi-piece wheel and integrated fiber optic system in accordance with an exemplary embodiment of the present invention.

FIG. 2A-D illustrate exploded views of a multi-piece wheel in accordance with an exemplary embodiment of the present invention.

FIG. 2E illustrates an assembled multi-piece wheel in accordance with an exemplary embodiment of the present invention, as shown in FIG. 2A-D.

FIG. 3A illustrates an assembled multi-piece wheel in accordance with an exemplary embodiment of the present invention, including a partial view of an exemplary lip assembly.

FIG. 3B illustrates a partial view of an exemplary lip assembly in accordance with an exemplary embodiment of the present invention, as shown in FIG. 3A.

FIG. 4 illustrates a faceplate for a multi-piece wheel in accordance with an exemplary embodiment of the present invention.

FIG. 5A illustrates a lip assembly in accordance with an exemplary embodiment of the present invention, including a partial view of an exemplary lip mounting flange.

FIG. 5B illustrates a partial view of a lip mounting flange in accordance with an exemplary embodiment of the present invention, as shown in FIG. 5A.

FIG. 6A illustrates a fully assembled multi-piece wheel in accordance with an exemplary embodiment of the present invention.

FIG. 6B illustrates a cross-sectional view of the multi-piece wheel in accordance with an exemplary embodiment of the present invention, as shown in FIG. 6A taken across line C-C, including a partial view of the lip assembly.

FIG. 6C illustrates a partial cross-sectional view of the multi-piece wheel in accordance with an exemplary embodiment of the present invention, as shown in FIG. 6B, including a partial view of the lip assembly.

FIG. 6D illustrates a partial cross-sectional cutaway of the lip assembly in accordance with an exemplary embodiment of the present invention, as shown in FIG. 6B-C.

FIG. 7A illustrates an exploded view of a multi-piece wheel in accordance with an exemplary embodiment of the present invention.

FIG. 7B illustrates an exploded view of a lip assembly in accordance with an exemplary embodiment of the present invention, as shown in FIG. 7A.

FIG. 8A illustrates a partial cross-sectional view of the multi-piece wheel in accordance with an exemplary embodiment of the present invention, as shown in FIG. 7A-B.

FIG. 8B illustrates a partial cross-sectional view of the lip assembly in accordance with an exemplary embodiment of the present invention, as shown in FIG. 7A-C.

FIG. 9 illustrates a light source, including control circuit, in accordance with an exemplary embodiment of the present invention.

FIG. 10 illustrates an optical fiber strand in accordance with an exemplary embodiment of the present invention.

FIG. 11 illustrates a bolt or rivet in accordance with an exemplary embodiment of the present invention.

Given the following enabling description of the drawings, the apparatus should become evident to a person of ordinary skill in the art.

### VI. DETAILED DESCRIPTION OF THE DRAWINGS

Referring now to the detailed description of the drawings, the invention is shown in several exemplary embodiments as applied to an automobile wheel having an independently rotating lip that is capable of freely spinning separately from the hub and faceplate of the wheel. The lip of the wheel rotates independently on a rail or bearing system that allows the forces acting on the wheel to set the rotating in motion. The rotating lip is free to rotate in the same or opposite direction as the wheel and at a variety of rates of rotation. In some embodiments, the wheel may also utilize optical fiber to transmit light from a light source on the wheel to direct rays of light onto the surface of the wheel. The fiber optic system, including light source, power source and control circuitry, is housed in a hermetically sealed compartment on the wheel.

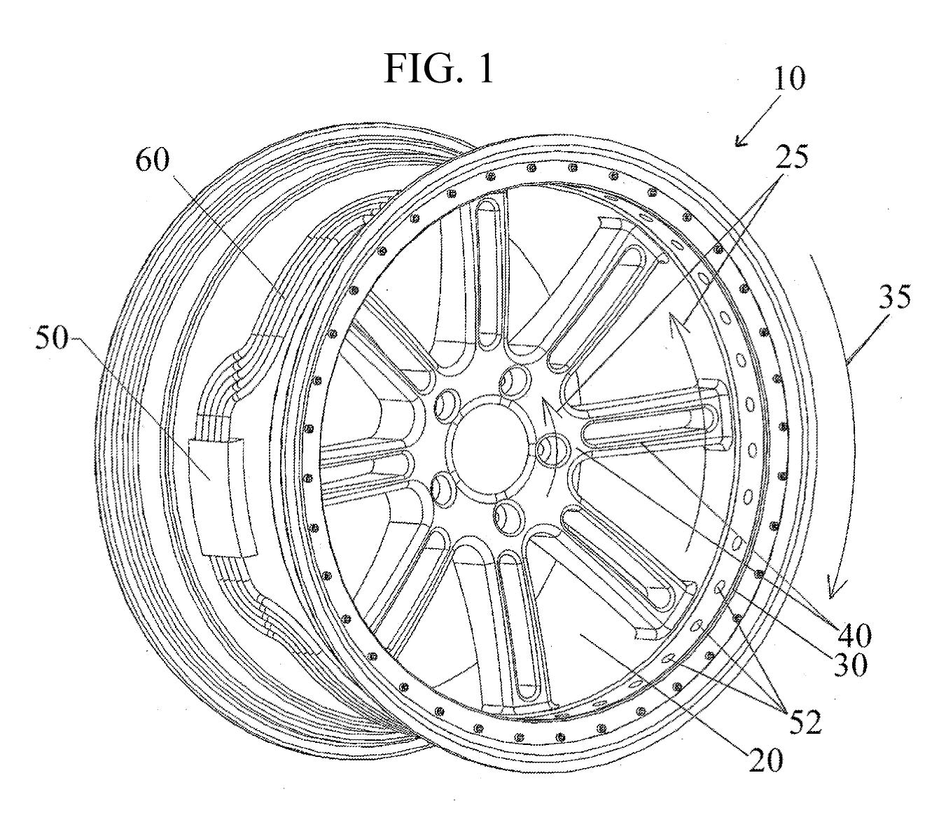

FIG. 1 illustrates an exemplary embodiment of a multi-piece wheel 10 having a bearing mechanism (not shown) attached to the wheel hub 20 that allows a rotating lip 30 to rotate freely and independently of hub 20 and spokes or faceplate 40. The faceplate 40 is fixedly attached to the hub 20 and the rotating lip 30 is rotatably attached to the hub 20 to form an integral multi-piece wheel 10. The hub 20 and faceplate 40 are fixedly attached and form a standard multi-piece wheel assembly wherein both the hub 20 and faceplate 40 move in the same direction (as shown by arrow 25). The attachment of the rotating lip 30 to the hub 20 via a bearing mechanism (not shown) permits the rotating lip 30 to rotate independently of the hub 20 and faceplate 40 (as shown by arrow 35). The rotating lip 30 is permitted to rotate in the same or different direction than the hub 20 and faceplate 40 and at a variety of rates of rotation.

The multi-piece wheel 10, as shown in the embodiment of FIG. 1, also includes an integrated, on-board fiber optic system which includes a light source 50 and optical fibers 60 that transmit light to the visible surfaces of the wheel 10, i.e. the rotating lip 30 and faceplate 40. The fiber optic system may be coupled to a surface of the hub 20 or lip 30 such that the optical fibers 60 leading from the light source 50 terminate adjacent windows 52 and/or 62 in the hub 20 and rotating lip 30, respectively. These windows 52, 62 allow light emitted from the optical fibers 60 to be transmitted onto the rotating lip 30 and faceplate 40 of the wheel 10 thereby creating a luminescent effect and enhancing the appearance of the wheel 10. The windows 52, 62 may be placed at a variety of positions along rotating lip 30 and at various angles to appropriately transmit light onto rotating lip 30 and faceplate 40. The windows 52, 62 may comprise various embodiments of optical glass and materials, including magnified optical material, cut optical material that produces refracted light, colored glass, jewel-like material, etc. Windows 52, 62 may also comprise voids that allow light or the optical fibers themselves to pass through to windows. When light source 50 and optical fiber 60 are disposed on lip 30, windows 62 may be eliminated.

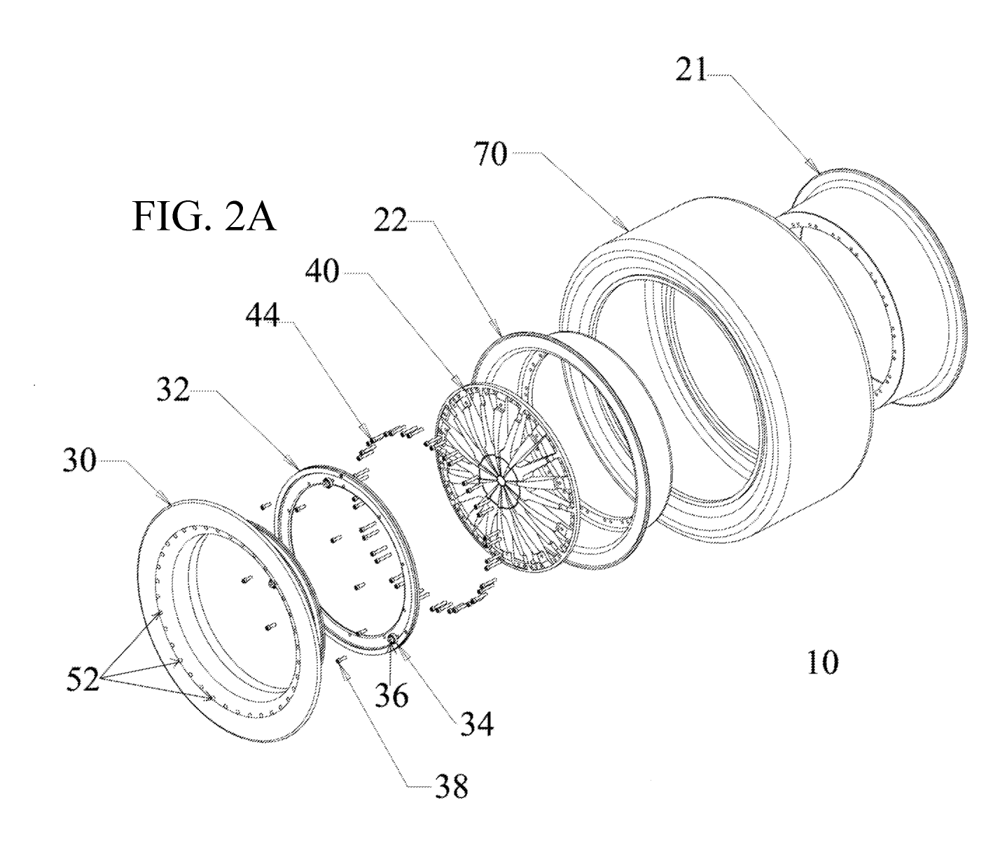

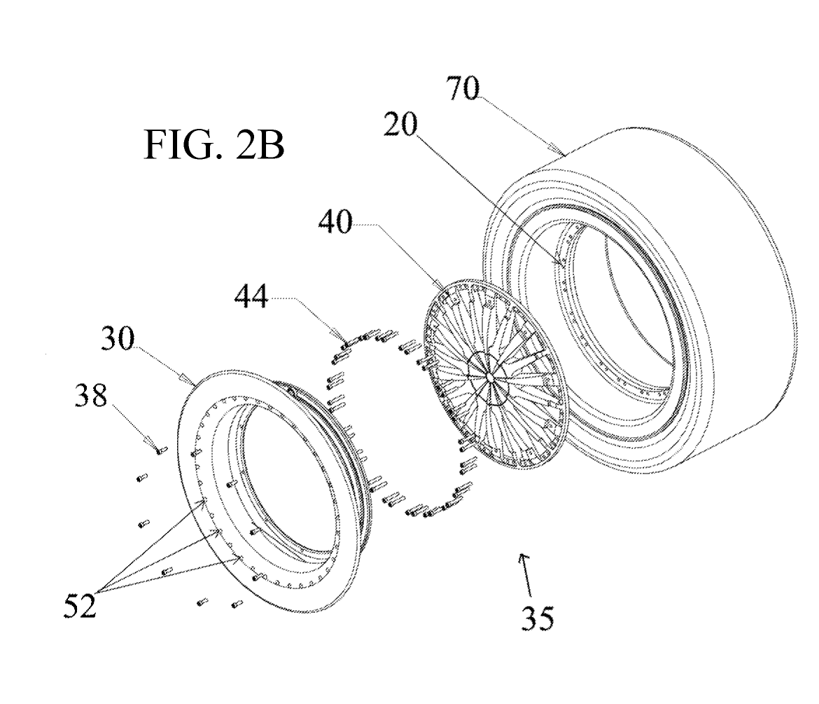

FIG. 2A illustrates an exploded view of an exemplary embodiment of a multi-piece wheel 10. An inner hub 21 and an outer hub 22 that are integrally connected to form hub 20. Tire 70 is placed on the perimeter of the hub assembly 21, 22. The faceplate 40 is attached to the perimeter of outer rim 22 with faceplate attachment screws 44. The rotating lip mounting flange 32 is connected to the faceplate 40 by rotating lip assembly attachment screws 38. The rotating lip mounting flange 32 includes an exemplary bearing system including roller bearings 34 connected to the rotating lip mounting flange 32 by shoulder screws 36. The rotating lip 30 is connected to the rotating lip mounting flange 32 via grooves (not shown) in the rotating lip 30 to form rotating lip assembly 35. The rotating lip 30 engages the roller bearings 34 such that the rotating lip 30 is permitted to rotate on the bearings independent of the hub 20 and faceplate 40. While at rest, the lip assembly 35, including the rotating lip 30, lip mounting flange 32 and roller bearings, replicates the appearance of a fixed lip multi-piece wheel. When the multi-piece wheel 10 is in motion the rotating lip 30 spins at a different rate relative to the hub 20 and faceplate. The mechanism for independently rotating the rotating lip 30 could include other low friction mechanisms, such as gas-filled, liquid-filled, counter-weighted, roller bearings (discussed below) or motor controlled assemblies.

FIG. 2B illustrates the partially assembled multi-piece wheel 10 outlined in FIG. 2A. Hub 21 and hub 22 are connected to form hub 20 and tire 70 is attached to hub 20. Rotating lip 30 is connected to lip mounting flange 32 via grooves (not shown) in the rotating lip that engage roller bearing 34 to form lip assembly 35.

FIG. 2C illustrates the partially assembled multi-piece wheel 10 outlined in FIG. 2B. Faceplate attachment screws 44 are connected to faceplate 40. Lip assembly attachment screws 38 are connected to lip assembly 35 to the faceplate 40 such that the rotating lip 30 is free to rotate on the lip mounting flange 32.

FIG. 2D illustrates the partially assembled multi-piece wheel 10 outlined in FIG. 2C. Faceplate 40 is connected to hub 20.

FIG. 2E illustrated the fully assembled multi-piece wheel 10 outlined in FIG. 2D. Rotating lip 30 is connected to faceplate 40 via lip assembly 35 and lip assembly attachment screws 38. Rotating lip 30 and faceplate 40 may comprise a variety of materials and designs, including for example carbon fiber, wood inlay, engravings, textures, artistic renderings, images, holograms, etc.

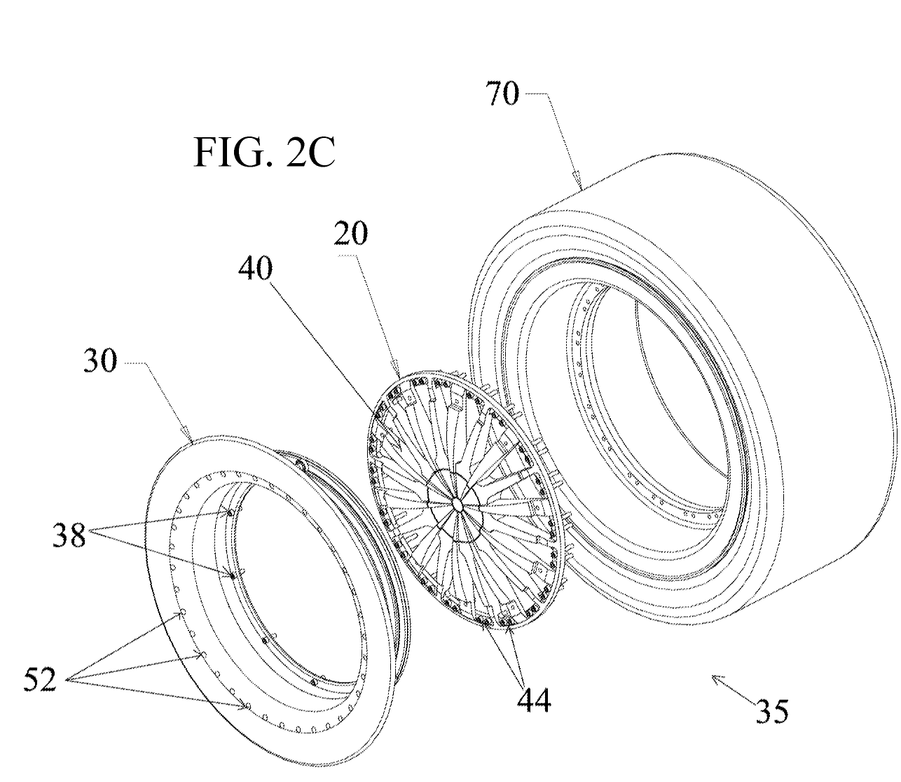

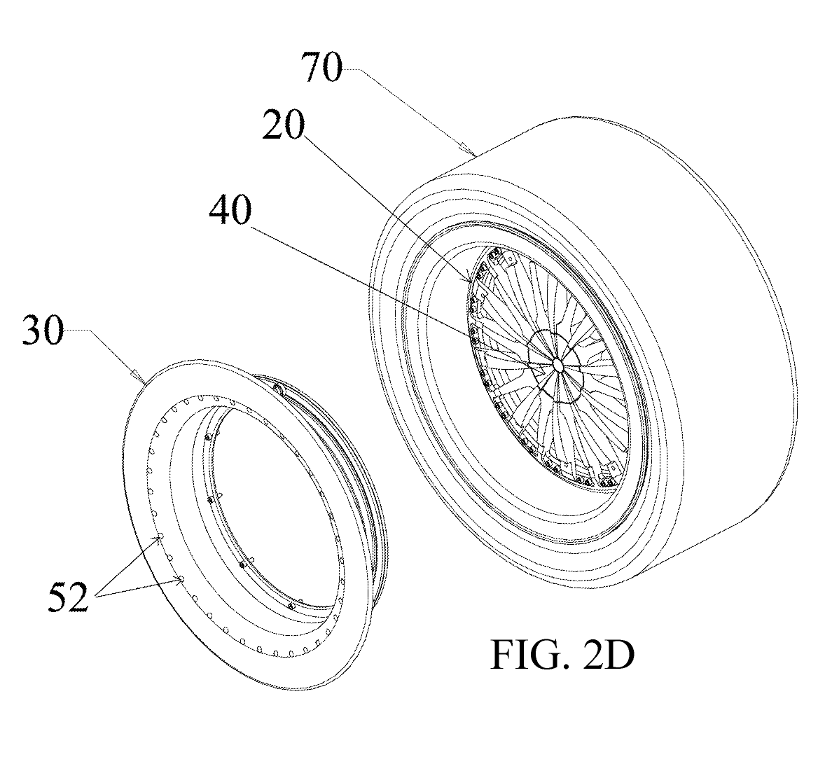

FIG. 3A illustrates a fully assembled multi-piece wheel 10 including a partial view G of a portion of the rotating lip 30, tire 70, and faceplate 40. The faceplate 40, as further illustrated in partial view FIG. 3B, includes faceplate attachment holes 42 (not shown) having faceplate attachment screws 44 that attach the faceplate 40 to the hub 20. The faceplate 40 also includes tapped holes 46 for attaching the lip assembly 35 to the hub 20 by lip assembly attachment screws 38, as shown in FIG. 2A-E.

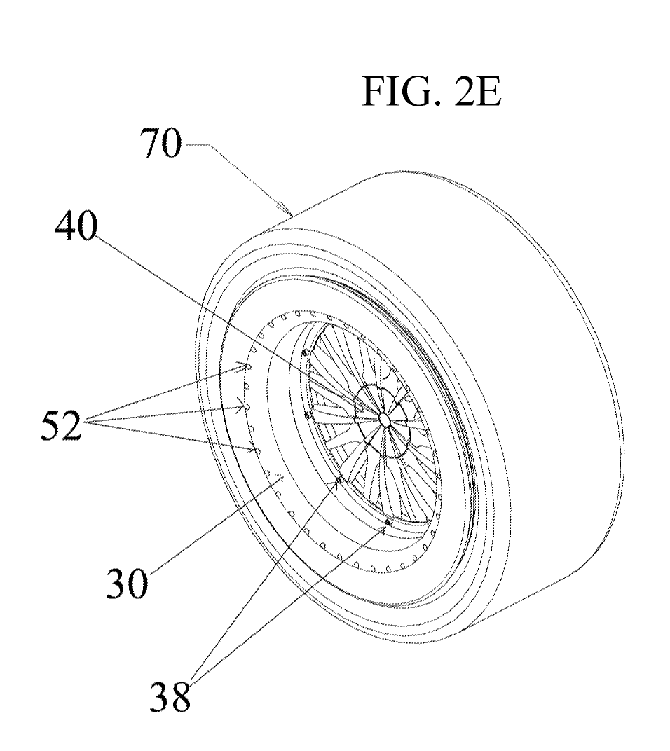

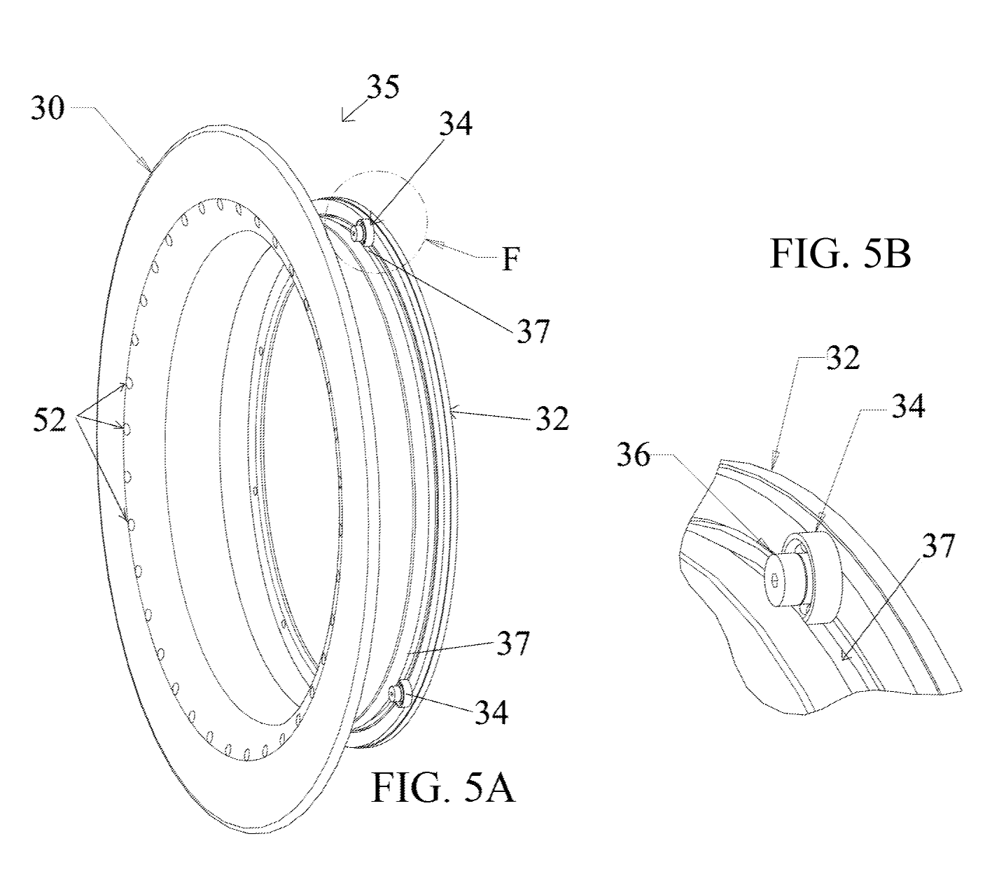

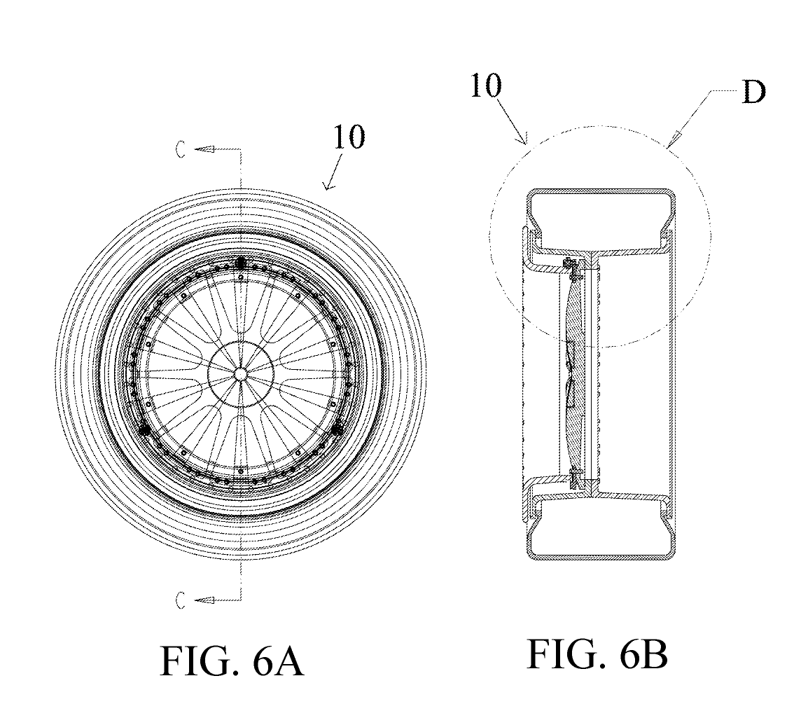

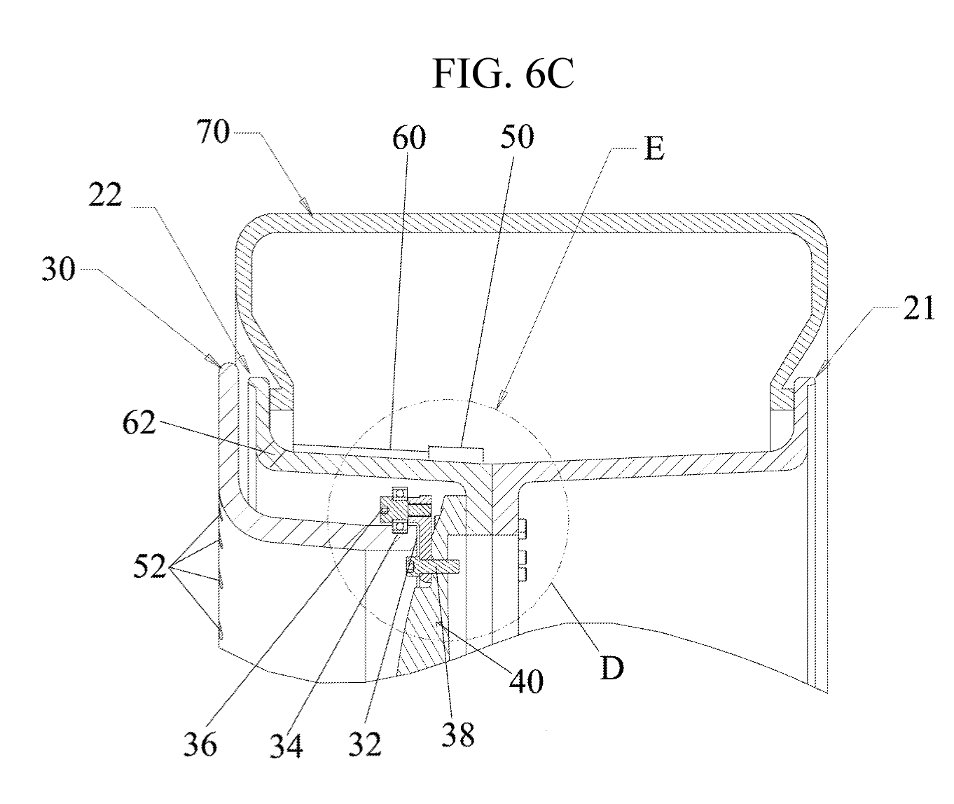

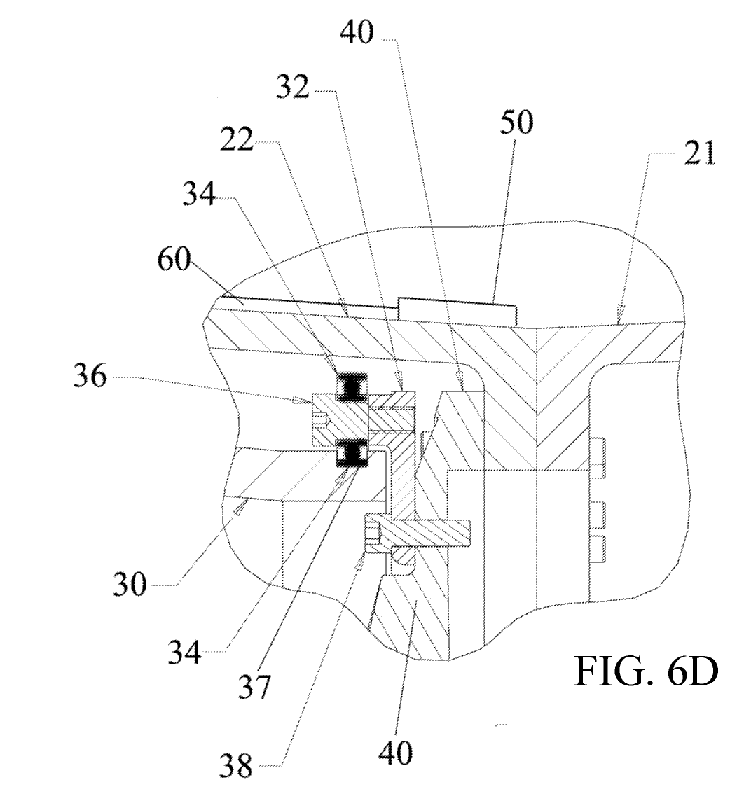

FIG. 4 illustrates an exemplary embodiment of faceplate 40 for multi-piece wheel 10. Faceplate 40 includes tapped screw holes 42 for attaching the faceplate 40 to the hub 20. Faceplate 40 also includes tapped holes 46 for attaching the lip assembly 35 to the hub 20 by lip assembly attachment screws 28. Faceplate 40 further includes a machined surface 48 that mates the back of the lip mounting flange 32 of the lip assembly 35, as shown in FIG. 6C-D.

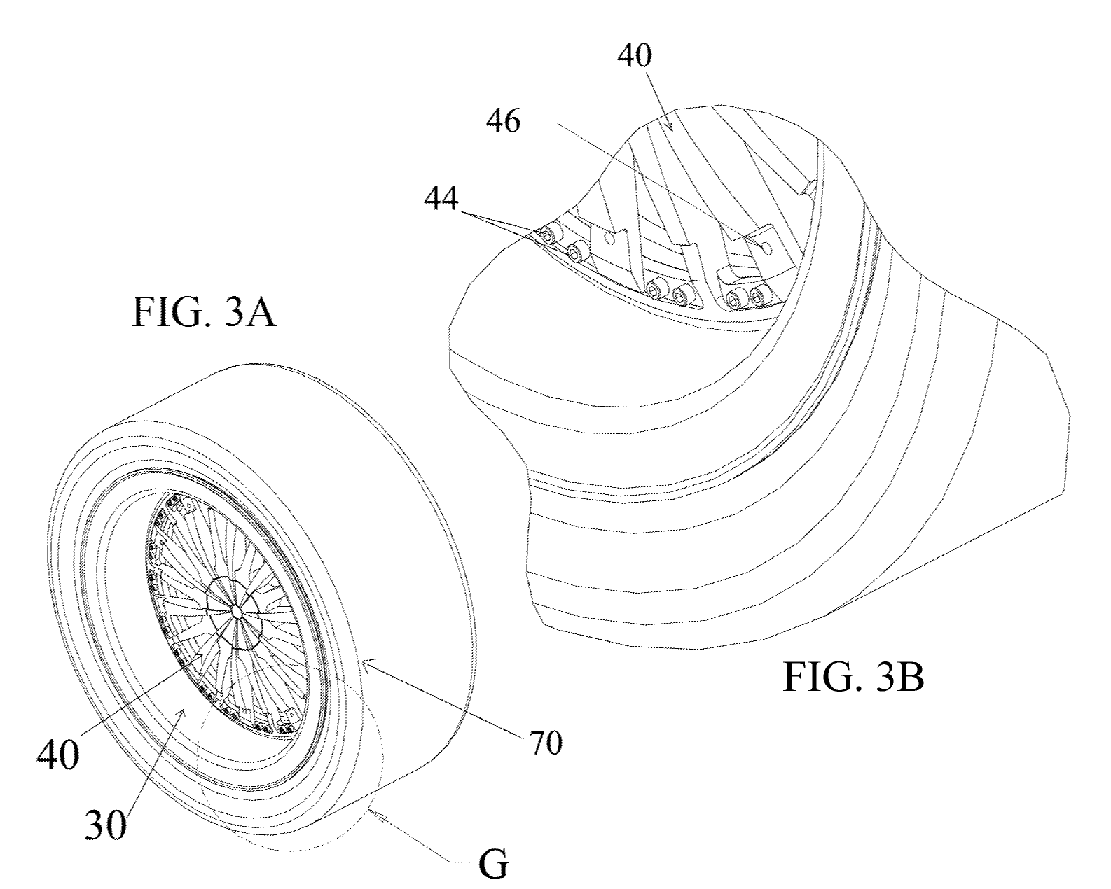

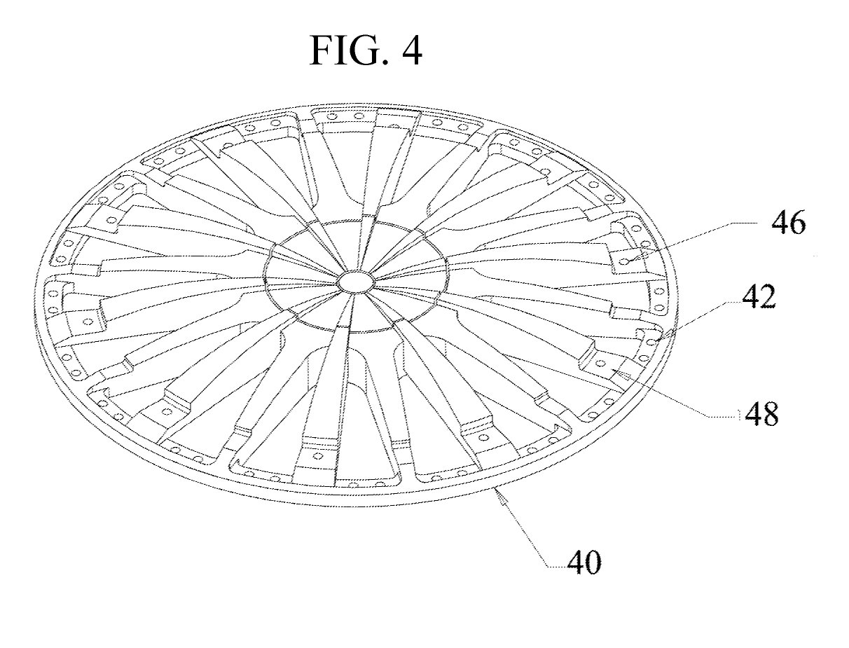

FIG. 5A illustrates an exemplary embodiment of a lip assembly 35 including a partial view F of a portion of the lip mounting flange 32. Lip assembly 35 includes rotating lip 30 and attached lip mounting flange 32. The rotating lip 30 includes a circumferential groove 37 for engaging the roller bearings 34 of the lip mounting flange 32. The roller bearings 34 freely roll on shoulder screws 36 that attach the roller bearings 34 to the lip mounting flange 32. The roller bearings 34, as shown in detail in partial view FIG. 5B, are seated within groove 37 of the lip mounting flange 32 which acts to rotatably secure the rotating lip 30 to the faceplate 40 of the multi-piece wheel 10. The groove 37 and roller bearings 34 engagingly cooperate to allow the rotating lip 30 to freely rotate on the roller bearings 34.

FIGS. 6A-D outline, in greater detail, the lip assembly 35 and rotating lip 30 of the exemplary embodiment of the multi-piece wheel 10, as described above. FIG. 6A illustrates a fully assembled multi-piece wheel 10. FIG. 6B illustrates a sectional view of the multi-piece wheel 10 illustrated in FIG. 6A across sectional line C-C, including partial view D.

FIG. 6C illustrates a cross-sectional cutaway of a portion of an exemplary multi-piece wheel 10 including a partial view E of the lip assembly 35. Partial view E is shown in greater detail in FIG. 6D. FIG. 6A-D show an inner hub 21, outer hub 22 and faceplate 40 coupled by screws 44 to form a standard multi-piece wheel along with tire 70. Light source 50 is coupled to outer hub 22 having optical fibers 60 that transmit light to windows 52. Lip mounting flange 32 is coupled to faceplate 40 by lip assembly attachment screw 38. Roller bearings 34 are attached to lip mounting flange 32 by shoulder screw 36 such that roller bearings 34 freely rotates on shoulder screw 36. Rotating lip 30 is rotatably connected to lip mounting flange 32 by roller bearings 34. Roller bearings 34 are engagingly seated within circumferential groove 37 on rotating lip 30 such that rotating lip 30 securely connects to multi-piece wheel 10 in a way that allows rotating lip 30 to freely and independently rotate with respect to the rest of the multi-piece wheel 10. Any number of roller bearings 34 may be used to securely and rotatably attach rotating lip 30 to lip mounting flange 32. Roller bearings 34 may be spaced substantially equidistant around lip mounting flange 30. For example, three roller bearings may be spaced substantially 120 degrees apart, four roller bearings may be spaced substantially 90 degrees apart, ten roller bearings may be spaced substantially 36 degrees apart, and so on. Roller bearings 34 are shown in FIGS. 6C-D as being disposed in circumferential groove 37 on an interior surface of the lip 30, i.e. the surface of the lip 30 adjacent the hub 20. However, circumferential groove 37 and roller bearings 34 may also be disposed on the exterior surface of lip 30, i.e. the surface of the lip opposite the hub 20, or even on both interior and exterior surfaces of lip 30.

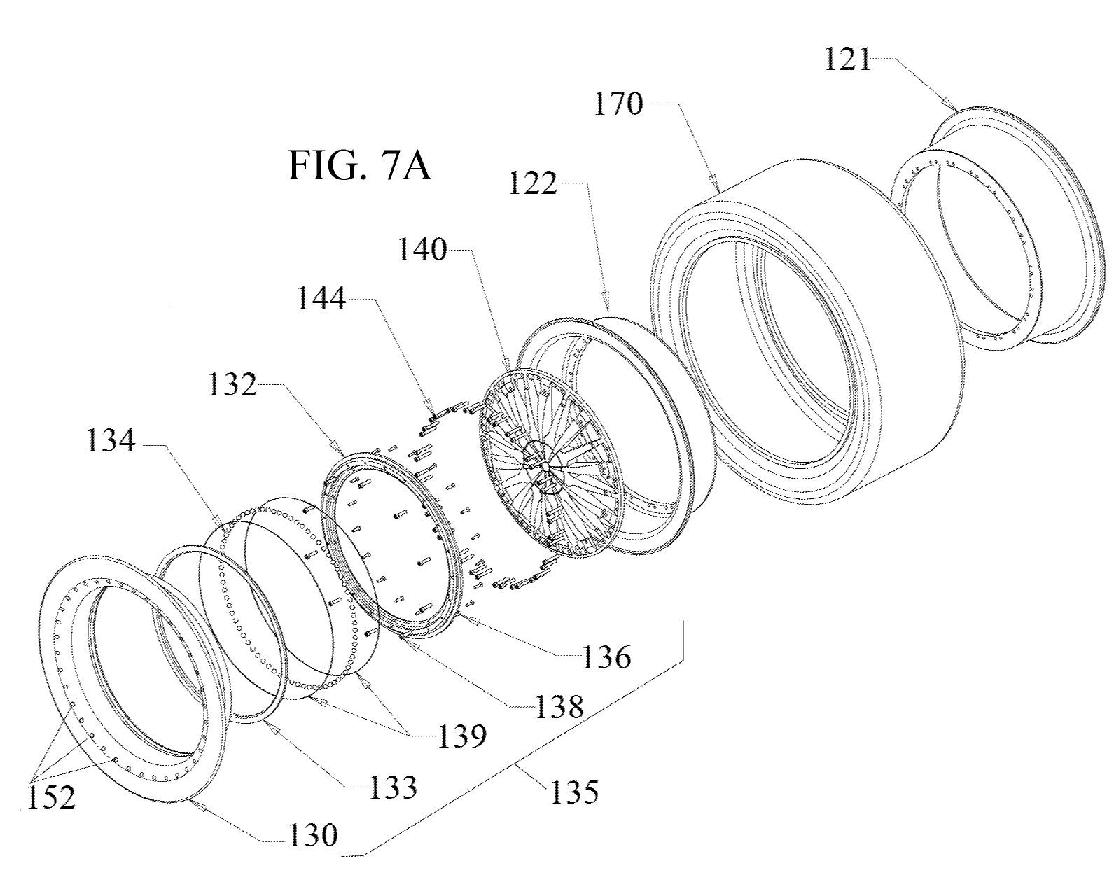

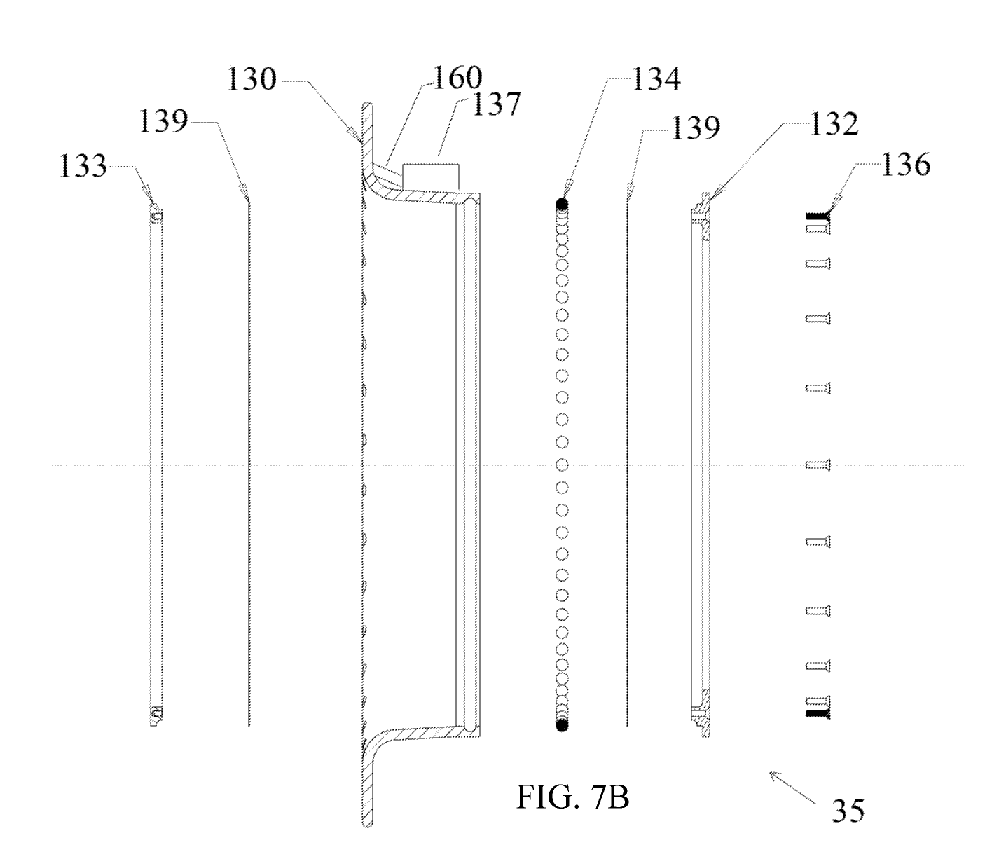

FIG. 7A illustrates an alternative exemplary embodiment of the multi-piece wheel 110 substantially similar to the multi-piece wheel 10 outlined in FIG. 2A. Inner hub 121, outer hub 122 and faceplate 140 are connected by screws 144 to form a standard multi-piece wheel assembly along with tire 170. Lip assembly attachment screws 138 are screwed through or along the lip mounting flange 132 and into screw holes 148 on the faceplate 140 to secure the lip assembly 130 to the multi-piece wheel to form a rotating lip multi-piece wheel 110.

Lip assembly 135, as shown in FIG. 7B, includes lip mounting flange 132, several ball bearings 134, seals 139, lip mounting flange cover 133 and rotating lip 130, including light source 150 and optical fiber 160, along with lip assembly screws 136 and lip assembly attachment screws 138. Lip mounting flange 132 and lip mounting flange cover 133 house several ball bearings 134 that are placed between two seals 139. The lip mounting flange cover 133 and a seal 139 are place on one side, e.g. the outer side, of the rotating lip 130. The ball bearings 134, a seal 139 and the lip mounting flange 132 are placed on the other side, e.g. inner side, of the rotating lip 130 with the ball bearing being disposed within a circumferential groove 137 on the rotating lip 130. Lip assembly screws 136 secure the lip mounting flange cover 133 to the lip mounting flange 132 enclosing the ball bearings 134 and seals 139 and rotatably securing the ball bearings within the circumferential groove 137. Light source 150 and optical fibers 160 are disposed on an interior surface of the rotating lip 130 such that optical fibers 160 terminate adjacent windows 152.

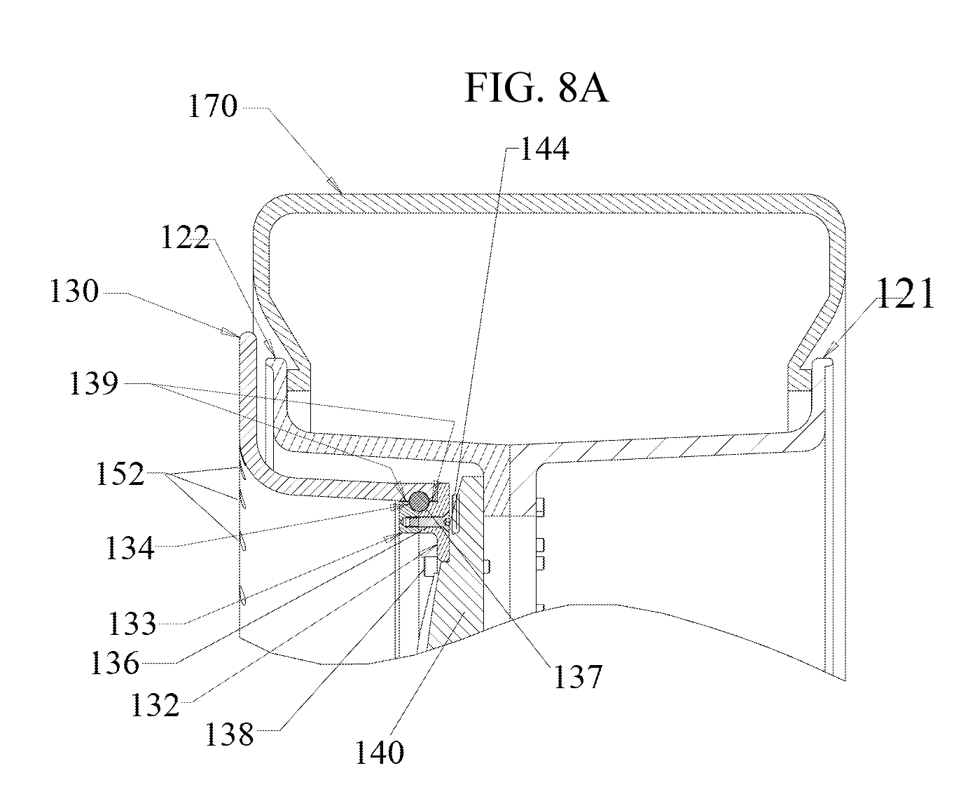

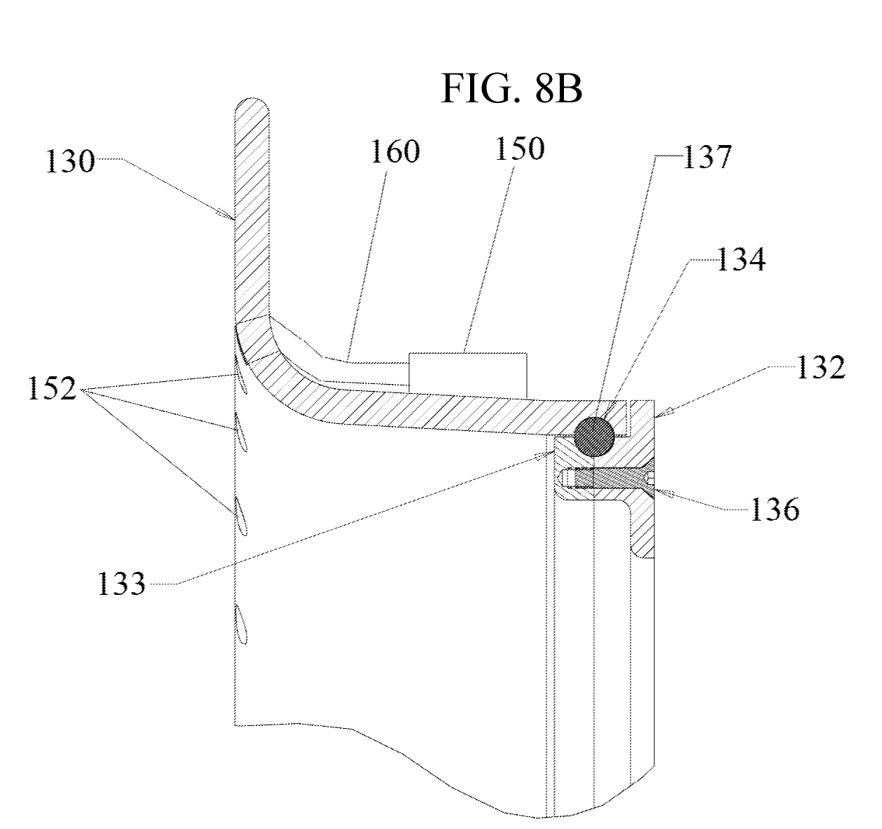

FIGS. 8A-B illustrate a partial cross-sectional cutaway of the alternative exemplary embodiment of multi-piece wheel 110 shown in FIGS. 7A-B. FIGS. 8A-B detail the lip assembly 135, including rotating lip 130. Rotating lip 130 includes a circumferential groove 137 on at least one surface of the lip 130 that engagingly and rotatably cooperates with ball bearings 134 and seals 139 on the lip mounting flange 132. Ball bearings are held in the lip mounting flange 132 by lip mounting flange cover 133 that is attached to the lip mounting flange 132 by lip assembly screws 136. Lip assembly 135 is connected to faceplate 140 of the multi-piece wheel 110 by lip assembly attachment screw 138. The lip assembly 135 functions to allow rotating lip 130 to freely and independently rotate with respect to the rest of the multi-piece wheel 110, i.e. the hub 120 and faceplate 140. Light source 150 transmits light to the windows 152 of rotating lip 132 via optical fibers 160. The transmitted light functions to enhance the luminescent and visual effect on the rotating lip 132 and faceplate 140.

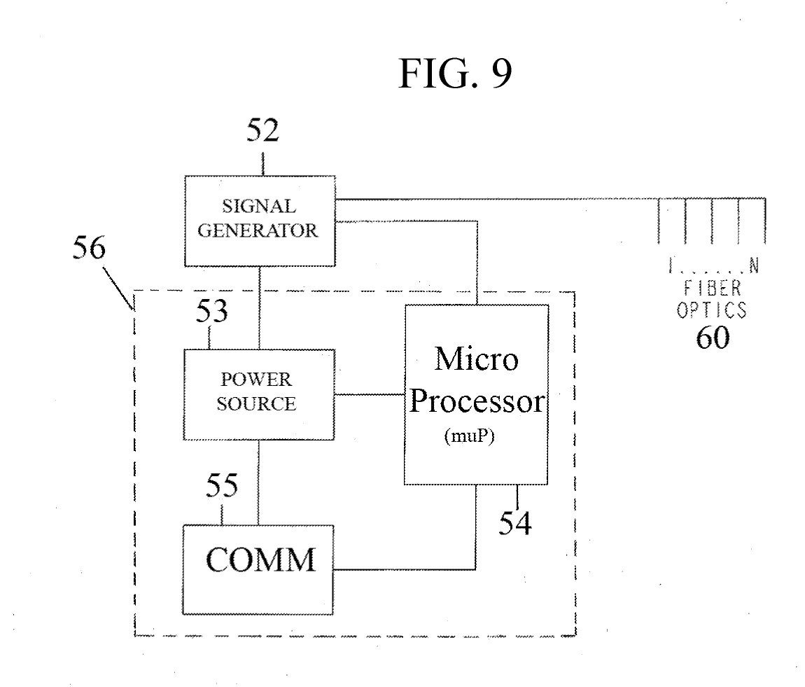

FIG. 9 illustrates an exemplary light source capable of controlling the illumination feature of the multi-piece wheel 10. Light source 50 includes a control circuit 56, signal generator 52 and optical fibers 51. The control circuit 56 controls signal generator 52 which emits light to multiple optical fibers 51 in order to illuminate and enhance the appearance of the multi-piece wheel 10. The control circuit 56 includes a power source 53, a programmable microprocessor or CPU 54, and a communication module 55, and is preferably contained in a hermetically sealed, impact-resistant housing along with signal generator 52 in order to protect the components from environmental elements. The communication module 55 is connected to the power source 53 and microprocessor 54 and enables a user to wirelessly communicate with the control circuit 56, including remotely controlling the ON/OFF state of the power source 53, the control functions of the microprocessor 54, e.g. the color, intensity or pattern of the light transmitted to optical fibers 51 from signal generator 52, etc. The communication module may utilize any of various communication protocols, including for example, serial communication, infrared (IR), radio frequency (RF), EMF, cellular, Bluetooth, and WAN. Microprocessor 54 may be programmed to control signal generator 52 to output a variety of lighting signals, including changing or varying the light color, changing or varying the lighting frequently, changing or varying the light quality or intensity, as well as controlling many other characteristics of the light generated. For example, the microprocessor 54 may be programmed with an algorithm designed to illuminate the wheels 10 on a predetermined cycle or to alternate between the colors of light generated by signal generator 52. The signal generator 52 and optical fibers are capable of producing and transmitting a broad range of colors and associated qualities and characteristics.

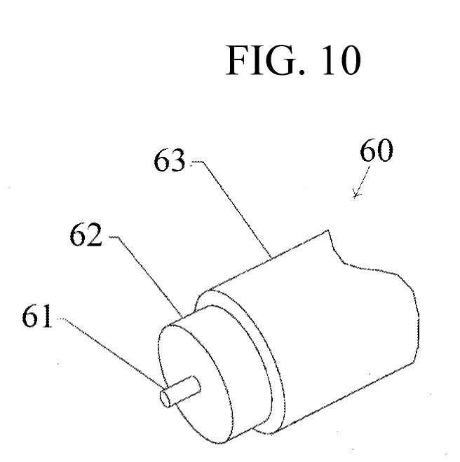

FIG. 10 illustrates a partial cutaway view an exemplary optical fiber 60 for use with the present invention. The optical fibers 60 may be made of glass or plastic. The optical fibers 60 may comprise any known variety of optical fibers suitable for transmitting visible light over short distances, including multimode and single mode fibers. Optical fibers 60 include core 61, cladding 62 and optional buffer 63 that together permit light to be transmitted from a source along the fiber.

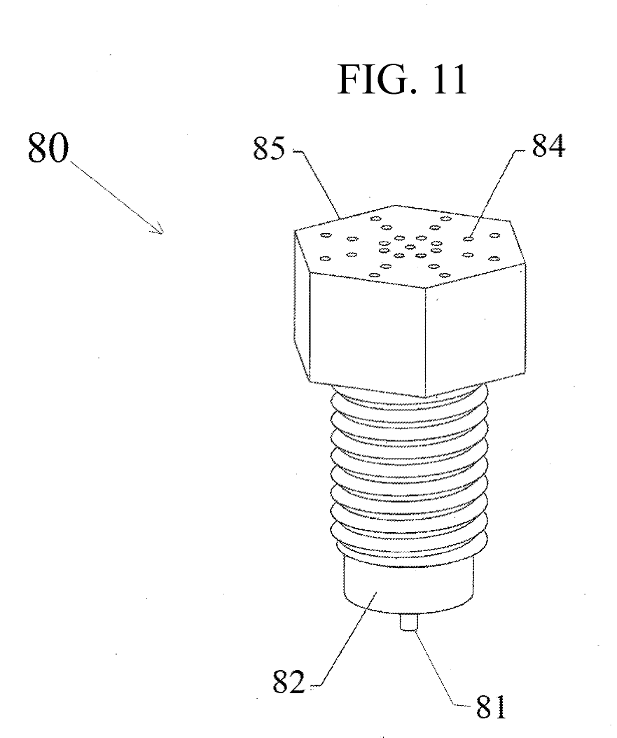

FIG. 11 illustrates a bolt or rivet 80 that may be used with the multi-piece wheel 10 of the present invention. The bolt or rivet 80 may be made of an integrated optical fiber core 81, cladding 82 and optional buffer (not shown). The bolt or rivet 80 functions to transmit light to an output 84 in the head 85 of the bolt or rivet 80. The output 84 may be formed as a pattern (as shown) or with no pattern. The bolt or rivet 80 may be placed in any compatible holes or fittings on the wheel 10. Preferably the holes or fittings are capable of receiving a light source such that the bolt or rivet 80 may be illuminated.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A multi-piece automotive wheel assembly comprising:
a hub;
a faceplate coupled to said hub; and,
a rotating lip coupled to said hub or faceplate, wherein said rotating lip rotates with respect to said hub or faceplate.

2. The multi-piece automotive wheel assembly of claim 1, further comprising:
a rotating lip mounting flange coupled to said hub or faceplate, wherein said rotating lip mounting flange includes a bearing system coupled to and spaced along said rotating lip mounting flange.

3. The multi-piece automotive wheel assembly of claim 2, wherein said rotating lip comprises at least one circumferential groove along at least one surface of said rotating lip, wherein said bearing system engages said circumferential groove such that said rotating lip rotates on said bearing system with respect to said faceplate or hub.

4. The multi-piece automotive wheel assembly of claim 2, wherein said bearing system comprises roller bearings.

5. The multi-piece automotive wheel assembly of claim 2, wherein said bearing system comprises ball bearings.

6. The multi-piece automotive wheel assembly of claim 1, further comprising:
an integrated lighting system coupled to said hub or rotating lip, wherein said integrated lighting system illuminates said rotating lip and faceplate.

7. The multi-piece automotive wheel assembly of claim 6, wherein said integrated lighting system comprises:
a light source that generates light;
optical fibers coupled to said light source, wherein said optical fibers transmit light generated by said light source to said rotating lip and faceplate.

8. The multi-piece automotive wheel assembly of claim 7, further comprising:
windows embedded in said rotating lip and/or said hub, wherein said optical fibers terminate adjacent said windows such that light is transmitted onto said rotating lip and faceplate.

9. The multi-piece automotive wheel assembly of claim 7, wherein said light source comprises:
a signal generator coupled to said optical fiber;
a microprocessor coupled to said signal generator;
a power source coupled to said signal generator and said microprocessor; and,
a communication module coupled to said power source and microprocessor, wherein said signal generator is controlled to output light to said optical fiber.

10. The multi-piece automotive wheel assembly of claim 7, further comprising:
at least one bolt or rivet placed in a hole on said wheel, said bolt or rivet having at least a portion formed of optical fiber capable of transmitting light, wherein said optical fiber terminate adjacent said bolt or rivet such that light is transmitted to a head of said bolt or rivet.

11. The multi-piece automotive wheel assembly of claim 10, wherein the head of said rivet or bolt may be formed as a pattern.

12. A multi-piece automotive wheel assembly comprising:
a hub;
a faceplate coupled to said hub;
a lip engaged with one of said hub and faceplate; and,
means for facilitating rotation of said lip with respect to said hub or faceplate.

13. The multi-piece automotive wheel assembly of claim 12, wherein said rotating lip comprises at least one circumferential groove along at least one surface of said rotating lip, and wherein said means for facilitating rotation of said rotating lip comprises a bearing system that engages said circumferential groove such that said rotating lip rotates on said bearing system with respect to said faceplate or hub.

14. The multi-piece automotive wheel assembly of claim 13, wherein said bearing system comprises roller bearings.

15. The multi-piece automotive wheel assembly of claim 13, wherein said bearing system comprises ball bearings.

16. The multi-piece automotive wheel assembly of claim 12, further comprising:
an integrated lighting system coupled to said hub or rotating lip, wherein said integrated lighting system illuminates said rotating lip and faceplate.

17. The multi-piece automotive wheel assembly of claim 16, wherein said integrated lighting system comprises:
a light source that generates light;
optical fibers coupled to said light source, wherein said optical fibers transmit light generated by said light source to said rotating lip and faceplate.

18. The multi-piece automotive wheel assembly of claim 17, further comprising:
windows embedded in said rotating lip and/or said hub, wherein said optical fibers terminate adjacent said windows such that light is transmitted onto said rotating lip and faceplate.

19. The multi-piece automotive wheel assembly of claim 17, wherein said light source comprises:
a signal generator coupled to said optical fiber;
a microprocessor coupled to said signal generator;
a power source coupled to said signal generator and said microprocessor; and,
a communication module coupled to said power source and microprocessor, wherein said signal generator is controlled to output light to said optical fiber.

20. The multi-piece automotive wheel assembly of claim 17, further comprising at least one bolt or rivet placed in a hole on said wheel, said bolt or rivet having at least a portion formed of optical fiber capable of transmitting light, wherein said optical fibers terminate adjacent said bolt or rivet such that light is transmitted to a head of said bolt or rivet.

21. The multi-piece automotive wheel assembly of claim 20, wherein the head of said rivet or bolt may be formed as a pattern.

22. A wheel lip assembly for attaching a rotating lip to a hub or faceplate of an automotive wheel, said lip assembly comprising:
a rotating lip mounting flange capable of being coupled to said hub or faceplate, wherein said rotating lip mounting flange includes a bearing system coupled to and spaced along said rotating lip mounting flange; and,
a rotating lip coupled to said rotating lip mounting flange, wherein said rotating lip rotates with respect to said hub or faceplate.

23. The wheel lip assembly of claim 22, further comprising an integrated lighting system coupled to said rotating lip, wherein said integrated lighting system illuminates said rotating lip and faceplate.

24. The wheel lip assembly of claim 23, wherein said integrated lighting system comprises:
a light source that generates light;
optical fibers coupled to said light source, wherein said optical fibers transmit light generated by said light source to said rotating lip and faceplate.

25. The wheel lip assembly of claim 24, further comprising:
windows embedded in said rotating lip and/or said hub, wherein said optical fibers terminate adjacent said windows such that light is transmitted onto said rotating lip and faceplate.

26. The wheel lip assembly of claim 25, wherein said light source comprises:
a signal generator coupled to said optical fibers;
a microprocessor coupled to said signal generator;
a power source coupled to said signal generator and said microprocessor; and,
a communication module coupled to said power source and microprocessor, wherein said signal generator is controlled to output light to said optical fibers.

27. A lighted wheel assembly, comprising:
a hub, including a lip;
a faceplate coupled to said hub;
a light source that generates light coupled to said hub or faceplate; and,
at least one optical fiber coupled to said light source, wherein said optical fiber transmits light generated by said light source to said hub or faceplate.

28. The lighted wheel assembly of claim 27, further comprising at least one window embedded in said hub or faceplate, wherein said optical fiber terminates adjacent said window such that light is transmitted onto said wheel.

29. The lighted wheel assembly of claim 27, wherein said light source comprises:
a signal generator coupled to said optical fiber;
a microprocessor coupled to said signal generator;
a power source coupled to said signal generator and said microprocessor; and,
a communication module coupled to said power source and microprocessor, wherein said signal generator is controlled to output light to said optical fiber.
